(19) United States
(12) Patent Application Publication
(10) Pub. No.: US 2003/0131476 A1
(43) Pub. Date: Jul. 17, 2003

(54) Heat conduits and terminal radiator for microcircuit packaging and manufacturing process

(76) Inventors: Vlad Ocher, San Diego, CA (US); Inocencio I. Rico, San Diego, CA (US); Andre K. Miller, San Diego, CA (US); David L. Rose, Cardiff, CA (US); Raymond J. Roszkowicz, Wildomar, CA (US)

Correspondence Address: CHARMASSON & BUCHACA, 1545 HOTEL CIRCLE SOUTH, SUITE 150, SAN DIEGO, CA, 92108-3412, US

(21) Appl. No.: 10/259,994

(22) Filed: Sep. 26, 2002

Related U.S. Application Data
(60) Provisional application No. 60/326,115, filed on Sep. 28, 2001.
(60) Provisional application No. 60/332,382, filed on Nov. 16, 2001.

(51) Int. Cl. B23P 13/04

(52) U.S. Cl. 29/890.03; 29/557

(57) ABSTRACT

A heat-dissipating element for the packaging of microelectronic components wherein conduits of higher thermal conductivity material extend through material having a compatible thermal expansion to the microelectronic component material. The element is formed by a porous compact of a high melting temperature material having bores formed between a surface located close to the microchip and a surface for contacting a heat sink or other heat dissipator. The compact is then infiltrated with a lower melting point material having a high thermal conductivity, thereby filling the bores to form heat conduits extending between the surfaces. Further enhancements provide integrated heat reservoir and radiator structures.

### FIELD OF THE INVENTION

This invention relates to powder metallurgy and more specifically to heat-dissipating elements for the packaging of micro-electronics selected to have a coefficient of thermal expansion compatible with the material used in the fabrication of microcircuits.

### BACKGROUND OF THE INVENTION

Most electronic microcircuit components require the use of structures which are capable of dissipating the heat generated by the active parts of the microcircuit. Moreover, those structures in direct contact with one another must have compatible thermal expansion characteristics. Otherwise, stresses caused by the disproportionate expansion may damage components, create separations between elements or otherwise reduce thermal dissipation efficiency.

The coefficient of thermal expansion (“CTE”) or simply the thermal expansion of a material is defined as the ratio of the change in length per degree Centigrade to the length at 25° C. It is usually given as an average value over a range of temperatures.

The thermal conductivity (“K” or “TC”) of a material is defined as the time rate of heat transfer through unit thickness, across unit area, for a unit difference in temperature or K=WL/AT where W=watts, L=thickness in meters, A=area in square meters, and T=temperature difference in OK or ° C.

In this specification with regard to microelectronic heat maintenance the term “high thermal conductivity” is generally meant to include those materials having a coefficient of thermal conductivity in excess of 120 watts per meter degree C. Similarly, with respect to coefficients of thermal expansion, those materials having a CTE below approximately 10.0×10⁻⁶/° C. will be said to have a “low” CTE. Those materials having a CTE above approximately 12×10⁻⁶/° C. will be said to have a “high” CTE.

Unfortunately, materials such as copper, silver, gold and aluminum which exhibit a high coefficient of thermal conductivity tend also to have CTEs much higher than materials such as gallium arsenide, silicon, and alumina used in the implementation microcircuit elements or their enclosures.

As disclosed in U.S. Pat. No. 4,680,618 Kuroda et al., it has been found convenient to use composites of copper and other denser metals such as tungsten or molybdenum in the fabrication of heatsinks, substrates and other heat-dissipating elements of microcircuit packaging. The proportions of the metals in the composite are selected to match the CTE of the material used in the fabrication of the active circuit component.

Due to the large differences in the specific gravities and melting-points, and lack of mutual solubility of metals such as copper and tungsten, for example, it is difficult to form composites of those two metals that exhibit a reliable degree of homogeneity using a conventional melting processes.

As disclosed in U.S. Pat. No. 5,086,333 Osada et al., incorporated herein by this reference, it has been found more practical to press and sinter a powder of the dense, higher melting point material, e.g., tungsten, to form a porous compact, then to infiltrate the compact with molten copper or another material having a lower melting point. The resulting metal matrix composite features both matched expansion characteristics and enhanced thermal conductivity. A slab of the composite can be cut and machined to form heatsinks, connectors, substrates and other heat-dissipating components or elements.

However, as even more densely populated microcircuit designs evolve, there is a need for accommodating even greater heat fluxes at lower cost.

With respect to larger elements or components such as heat-dissipating substrates for high power components, the material cost of the metal becomes an important factor. There is therefore a benefit to reducing a dependence on costly metals.

With respect to heat-dissipating elements for packaging microprocessors, a popular design is the so-called “flip chip” type package as disclosed in U.S. Pat. No. 5,585,671 Nagesh et al. and in U.S. Pat. No. 6,250,127 B1, Polese, et al. incorporated herein by this reference. As shown in FIG. 1, this package design has seen the development of a heat-dissipating cover or lid structure 5, also known as a heat spreader, which is bonded to the back side, or in the shown orientation, upper surface of the die 1 using a layer of thermally conductive adhesive 6 such as conductive epoxy or solder. A stiffener 7 laterally surrounds the die and bonds the periphery 8 of lid to the interconnecting ceramic substrate or printed circuit board 3 thereby enclosing and protecting the die, preserving good contact at the die-to lid interface, and allowing the use of non-adhesives such as thermal grease at the interface. The die 1 has a plurality of solder bumps 2 arranged on its active side, or in the shown orientation, underside to electrically interconnect the die to the circuit board 3. Typically, an underfill layer 4 of electrically insulating polymer further bonds the die to the circuit board reducing mechanical stresses created by any die-to-circuit board CTE mismatch. Since most commercially practical insulating polymers have relatively poor thermal conductivity, it is important for the lid to carry a large proportion of the heat from the die.

FIGS. 2 and 3 show that the stiffener may be integrated with the lid by forming the lid 9 to have a thickened periphery or flange 10 terminating at the inner edge(walls 11, 12 forming an underside cavity 13. FIG. 2 also shows the need for lids having a uniformly smooth and flat upper surface for intimately contacting a top-mounted radiator 14. Because of the importance of heat-dissipation attributable to the radiator, there is a need to maximize the heat transfer ability of the lid.

Due to the relatively poor thermal conductivity of the interface layer between the die and the lid, minimum thickness is desired, leading to the need for a smooth, flat lid undersurface, and well-matched thermal expansion characteristics. However, if adhesive is used, a thinner epoxy layer is less capable of accommodating any expansion mismatch between the die, the lid, and the ceramic substrate leading to breaks in the contact surfaces.

In many microcircuit devices more heat may be produced from particular locations of the die than others. Also, heat output may fluctuate from any particular location over time. There is therefore a need to accommodate variations in heat output over time and location.

The instant invention therefore results from an attempt to devise a simpler, more practical and more economical heat-dissipating element design and process of manufacture which address the issues described above.

### SUMMARY OF THE INVENTION

The principal and secondary objects of this invention are to provide an inexpensively manufactured heat-dissipating element for use in the packaging of heat-generating microcircuits, wherein the element has an enhanced heat transfer and dissipation capability and has a CTE compatible with the microcircuit material while maintaining adequately uniform smoothness and flatness.

These and other objects are achieved by a CTE matched metal matrix composite combining a higher thermal conductivity material with a lower CTE material in which the composite has heat conduits formed through it by the higher thermal conductivity material. Each heat conduit is located to have a first end surface or pad in close proximity to the heat source, e.g., semiconductor die, and a second end surface or pad in close proximity to other heat-dissipating structures.

Various embodiments provide an improved tapered or conically shaped heat conduit reducing mechanical stresses while maintaining high heat throughput, differing size and orientation of heat conduits depending on the size and contact location of the die.

In a further embodiment, heat conduit locations can be selected to form symbols, letters and words to provide a unique informational media.

In a further embodiment, heat conduits may connect parallel plates sandwiching the CTE matched material.

These elements are formed through an inventive process which involves creating a porous preform of higher melting point, low CTE material such as tungsten, which has a plurality of spaced-apart bores corresponding to the conduits. The preform is then infiltrated with a lower melting point, high thermal conductivity material such as copper to form a metal matrix composite and to fill the bores.

In a further embodiment of the invention, bores are formed in the preform in a single pressing process using a die press having prominences associated with the bores.

In a further embodiment of the invention, conduits extend through an interconnecting heat reservoir and terminate in a radiator structure.

### BRIEF DESCRIPTION OF THE DRAWING

FIG. 1 is a prior art diagrammatic cross-sectional view of a flip chip-type integrated circuit die mounted upon a circuitboard and having a heat-dissipating lid with stiffener;

FIG. 2 is a prior art diagrammatic cross-sectional view of a flip chip-type integrated circuit die mounted upon a circuit board and having a heat-dissipating lid and a radiator;

FIG. 3 is a prior art diagrammatic perspective view of an inverted flip chip lid showing its underside;

FIG. 4 is a diagrammatic perspective view of an inverted flip chip lid according to the invention showing its underside and heat conduit pads;

FIG. 5 is a diagrammatic cross-sectional view of the lid of FIG. 4 taken along line 5-5 and uprighted;

FIG. 6 is a close-up diagrammatic cross-sectional view of the lid of FIG. 5 showing heat conduits and attached die;

FIG. 7 is a diagrammatic plan view of a pattern of uniformly sized and spaced conduits;

FIG. 8 is a diagrammatic cross-sectional view of an alternate embodiment of the invention showing variably sized heat conduits and dissipation plates;

FIG. 9 is a diagrammatic cross-sectional view of an alternate embodiment of the invention showing variably shaped and oriented heat conduits;

FIG. 10 is a diagrammatic perspective view of a high power transistor substrate having heat conduits arranged to form a word;

FIG. 11 is a flow chart diagram of the generalized process of the invention;

FIG. 12 is a flow chart diagram of a first embodiment of the process of the invention;

FIG. 13 is a diagrammatic cross-sectional view of an die press according to an alternate embodiment of the invention process;

FIG. 14 is a diagrammatic cross-sectional view of an die press according to another alternate embodiment of the invention process;

FIG. 15 is a diagrammatic perspective view of a flip-chip lid having an integrated reservoir/radiator structure of the invention;

FIG. 16 is a diagrammatic cross-sectional view of the lid of FIG. 15 taken along line 16-16;

FIG. 17 is a diagrammatic cross-sectional view of the lid of FIG. 16 bonded to a substrate mounted flip-chip;

FIG. 19 is a diagrammatic exploded perspective view of the preassembled components of the reservoir/radiator embodiment of the invention;

FIG. 20 is a diagrammatic flow chart pictogram showing a first part of the process embodiment for manufacturing the reservoir/radiator structure;

FIG. 21 is a diagrammatic flow chart pictogram showing a middle part of the process embodiment for manufacturing the reservoir/radiator structure;

FIG. 22 is a diagrammatic flow chart pictogram showing a last part of the process embodiment for manufacturing the reservoir/radiator structure; and

FIG. 23 is a diagrammatic cross-sectional view of the an alternate process embodiment wherein as superimposed slab of infiltrant material replaces the rods of an earlier embodiment.

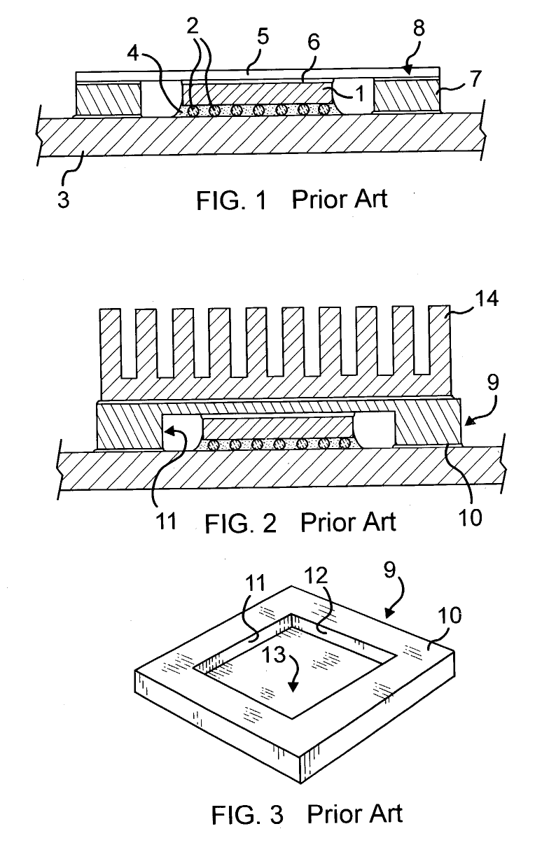

### DESCRIPTION OF THE PREFERRED EMBODIMENT OF THE INVENTION

The preferred embodiment of the invention will be described in relation to the manufacture of a metal matrix composite copper-tungsten heat spreader in the form of a flip chip lid. It is clear to those skilled in the art that the invention is applicable to the manufacture of other heat-dissipating structures such as heatsinks, high power transistor substrates, optical switch substrates, covers, baseplates, housings, other heat spreaders and other heat-dissipating elements for thermal management of microelectronics components.

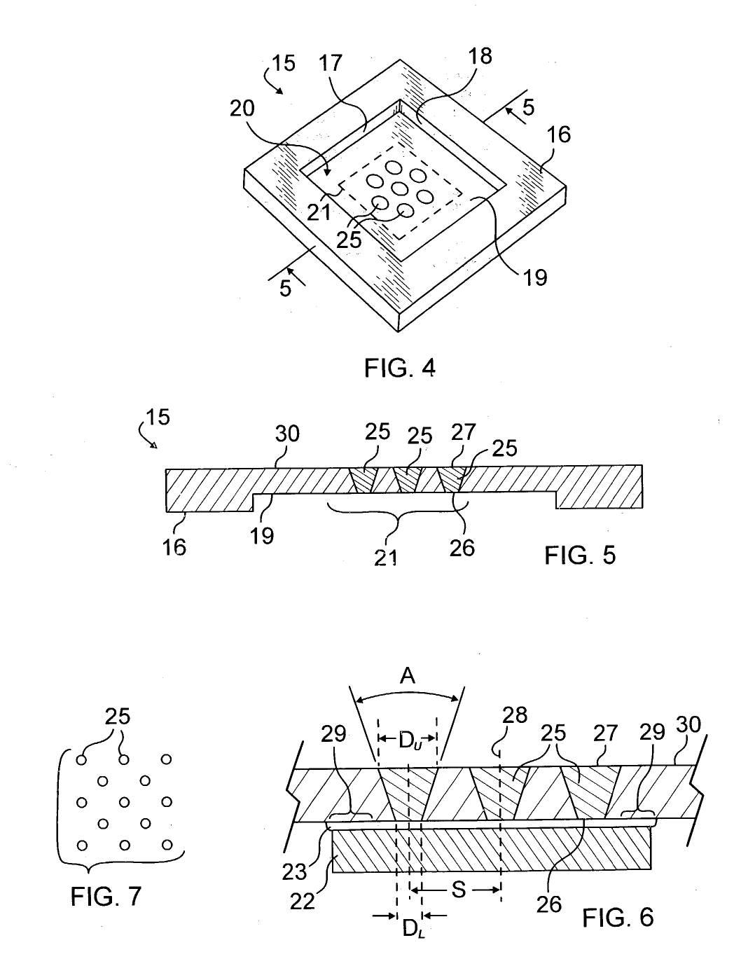

Referring now to the drawing, there is shown in FIGS. 4-6, a flip chip lid according to the invention. The lid 15 has a thickened periphery or flange 16 terminating at inner edge walls 17, 18 and an underside surface 19 forming a cavity 20. A medial region 21 of the underside surface corresponds to an area contacted by a micro-electronic die 22 or its mounting material layer 23 such as thermal epoxy, thermal grease or a eutectic bond zone. Within the region of contact 21 are situated the first ends or pads of a plurality of heat conduits 25 formed from a high thermal conductivity material such as copper. The remainder of the lid is formed from a CTE matched material such as a substantially homogeneous composite of tungsten and copper.

Each heat conduit 25 comprises a generally cylindrical, tapered or conical body having a circular bottom end surface or pad 26 level with the undersurface of the cavity 19 and a circular opposite top end surface or pad 27 level with the top surface 30 of the lid. The pad surfaces are level with their adjacent surfaces to maintain flatness to enhance close contact with the die or radiator respectively.

Those skilled in the art will readily appreciate other shapes and three-dimensional structures for the conduits depending on the application. Conduit size, density, and pattern will also depend on the application. In general, local thermal conductivity is maximized by a greater number or size of conduits in a given area. However, this must be balanced against ease of manufacture, structural integrity and the acceptability of a CTE mismatch. Simple geometric cross-sections are preferred for ease in manufacturing. Smooth shapes such as cylinders having circular cross-sections are preferred if the preform bores are formed through drilling as described below. Partial cones are preferred for press-formed bores as described below.

For example, from a functional standpoint, a localized volumetric balance between the copper heat conduits and the copper-tungsten composite material is preferably maintained in order to maximize the localized thermal conductivity, while at the same time, maintaining acceptable localized CTE. Additionally, this balance helps to minimize thermal stresses generated between the two materials over a functional temperature range. These design considerations are typically determined by the particular application's requirements with respect to thermal conductivity and thermal expansion.

If each conduit is uniformly shaped and spaced, those skilled in the art will readily appreciate that conduit density is maximized for a given area by the pattern shown in FIG. 7 wherein four conduits form corners of a square which has a fifth conduit in the center, wherein the corner conduits are in common with adjacent squares.

As shown in FIG. 6, each of the conical conduits 25 are oriented to have the smaller surface area pad 26 facing the die to reduce the effect of the CTE mismatch between the conduit material and die material. The surface area of the top pad 27 is greater so as to enhance multi-dimensional heat flow and to match the CTE of a structure such as a copper radiator or other heat-dissipator.

If a conical shape is used for the heat conduits, and the major axis 28 is perpendicular to the parallel top and underside lid surfaces 30,19, the lower circular pad will have a diameter D_{L} which is less than the diameter of the circular upper pad. The respective surface areas will also be a function of the cone angle A.

Adequate spacing S between the heat conduits is required to maintain thermal expansion compatibility. The spacing depends, of course, on heat conduit size and shape.

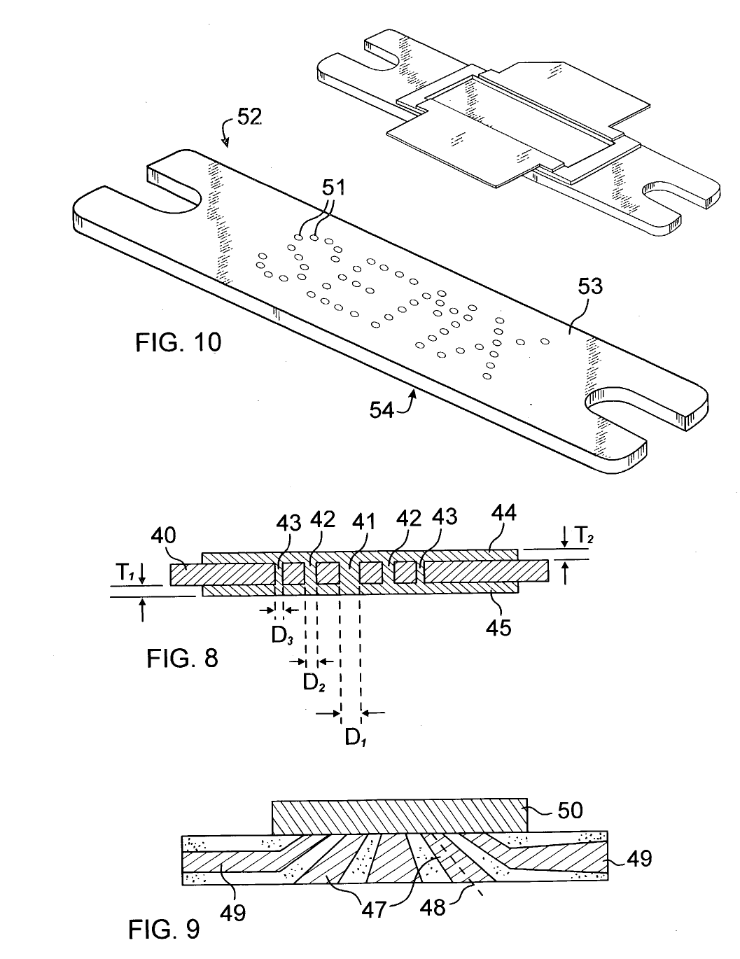

For many components such as microprocessors, different portions of the die may generate more heat. If such portions are known, one may selectively place a higher density or larger conduits which correspond to those portions. Referring now to FIG. 8, there is shown a metal matrix composite substrate 40 having heat conduits 41,42,43 formed therein extending through the substrate. The conduits are cylindrically shaped and have sizes and locations selected to maximize heat transmission while maintaining adequate expansion characteristics. In this case, a central heat conduit 41 of a first diameter D₁ is larger than its adjacent heat conduits 42 which, in turn, have diameters D₂ larger than the diameters D₃ of the next further adjacent heat conduits 43. In this configuration, the ratio between the diameter of adjacent heat conduits should be selected to maintain localized volumetric balance. Further, the use of heat-dissipating top and bottom plates or layers 44,45 can be formed during the infiltration process using well-known techniques to provide the excess molten metal. The thickness T₁,T₂ of the top and bottom plates are selected to be closely equal to avoid warpage which would occur due to disproportionate expansion of the plates were they of different thicknesses. These two features, namely the different sized conduits and the sandwich plates, are disclosed together merely for the sake of brevity and are in no way required to be used together as shown.

As shown in FIG. 9, in an alternate embodiment, tapering or conically shaped heat conduits 47 have non-perpendicular major axes 48 and other heat conduits 49 have non-symmetrical shapes to carry heat from a microchip 50.

In an additional embodiment, referring now to FIG. 10, due to the visual contrast created by the different materials used form the heat conduits and the surrounding substrate, the selection and arrangement of heat conduits 51 can be made to create letters or other symbols which would convey information about the device such as its characteristics, its manufacturer or to convey other information for various purposes including advertising. In the present embodiment, the word “SEMX” is formed in capital letters by a plurality of heat conduits 51 extending from the upper surface 53 of a LDMOS-type high power transistor substrate 52 through to a bottom surface 54 which would, in turn, contact a heat-dissipating carrier. In this way, the power transistor would be mounted upon the upper surface of the substrate covering the heat conduit upper pads.

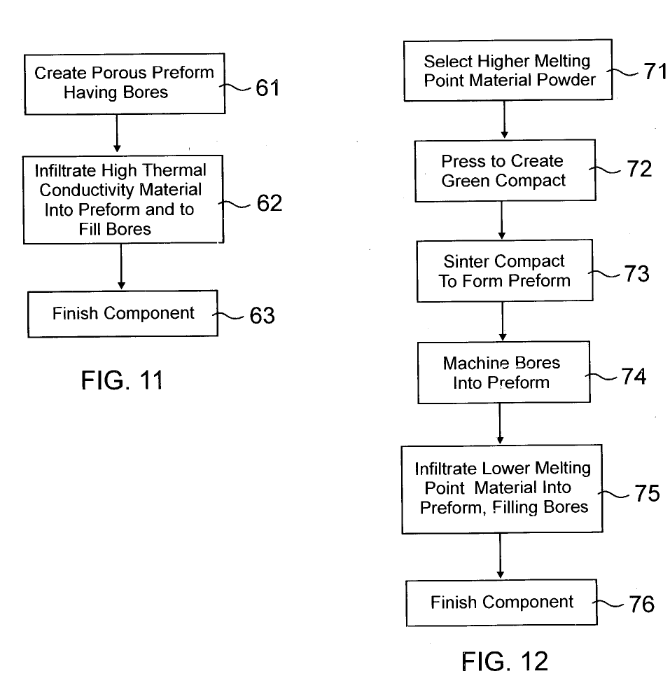

Referring now to FIG. 11, the preferred process for manufacturing a heat-dissipating element for microelectronic packaging will include first creating a porous preform of high melting point material having bores interconnecting separated surfaces 61, then infiltrating a low melting point infiltration material into the preform and to completely fill the bores 62, then finishing the component 63 to form the surfaces which will connect the high heat source to the heat-dissipator through heat conduits.

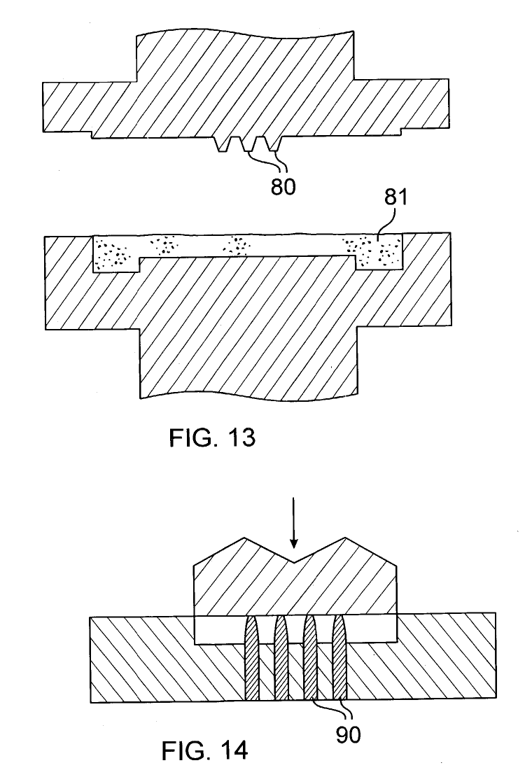

Referring now to FIG. 12, the preform is created by selecting 71 a first quantity of powder particles of a first material having a relatively low CTE, and a relatively high melting point such as tungsten, molybdenum, rhenium, iron-nickel alloys, iron-nickel-cobalt alloys and composites and alloys thereof. The particles of may have been formed by techniques well-known to those skilled in powder materials science, powder metallurgy, and conventional metallurgy. The particles can also be preagglomerated particles of the metals with other metals such as cobalt and nickel to enhance sinterability.

The powder of the first material is then press-molded to form a porous grain compact 72. The density of the compact must be less than theoretical to allow voids to be

### EXAMPLE 1

Many flip chip lids were attempted. Below are provided a range of parameters and those most preferred in this particular example. Preferred and most preferred values will vary greatly depending on the application.

An amount of tungsten powder is selected having a particle diameter of between about 0.1 and 100 microns and more preferably, an average particle diameter between about 0.5 and 25 microns. The powder is at least approximately 99.0% tungsten with the remainder being binder or impurities. Such powder is available from Osram-Sylvania of Towanda, Pa.

The tungsten powder is loaded into a hopper which feeds powder into a ram-type press-molding tool which operates at room temperature under a pressure of between about 35 and 75 tons per square inch (“tsi”), and most preferably about 55 tsi. Ram speeds were selected to range between about 2 and 30 inches per second (“ips”), and most preferably about 10 ips. Dwell time at pressure was selected to range between about 2 and 20 seconds, and most preferably about 5 seconds. Ejection speeds were selected to range between about 2 and 25 ips, and most preferably about 10 ips.

The press ejects a porous compact structure measuring approximately 2.5 inches×2.5 inches×0.2 inches in the shape of a flip chip lid. The resulting porous green compact had a density of between about 63% and 89% of theoretical and most preferably approximately 76% of theoretical.

The compact was placed in a continuous sintering furnace having preheat, high temperature and cooling zones and a reducing atmosphere. The high temperature zone, which has the greatest effect on the sintering, was set between about 1150 degrees C. and 1350 degrees C., most preferably about 1250 degrees C. Exposure time was between about 15 and 120 minutes, most preferably about 60 minutes.

After cooling, the sintered porous preform was drilled in a CNC type drilling machine to form cylindrical bores having a diameter between about 0.031 and 0.0625 inch, and most preferably about 0.040 inch. Distance between hole centers was at least 1.5 time the hole diameter, and most preferably about 2 times the hole diameter. The pattern of the bores was as shown in FIG. 7 and other patterns including those forming symbols.

An adequate amount of “oxygen free high conductivity” type copper having 99.9% minimum copper content, the remainder being other alloying elements and impurities, in the form of a plate measuring 2.5 inches×2.5 inches×0.050 inches was staged with the preform in a graphite boat and placed in a continuous sintering oven. In this infiltration oven, the high temperature zone was set between about 1100 degrees C. and 1350 degrees C., most preferably about 1150 degrees C. Exposure time was between about 1 hour and 8 hours, most preferably about 5 hours.

After cooling, the resultant infiltrated preform was then grinded to remove excess copper and cleaned using techniques well known in the industry to form the finished flip chip lid.

As shown in FIG. 13, in an alternate fabrication embodiment, an amount of preform powder 81 is pressed in a die press having prominences 80 corresponding to the formation of bores into the compact.

Referring now to FIG. 14, bores are formed during the compact pressing stage using core pins 90 mounted within the die cavity 91. Adequate draft on the core pins requires a general tapering of the diameter from the bottom up which inexpensively creates the tapered or conically shaped bores described above.

Now will be described an alternated embodiment of the invention providing integrated heat conduit, heat reservoir and heat radiator structures in a microcircuit package. As with the previous embodiments, this embodiment will be described in relation to the manufacture of a flip chip lid. It is clear to those skilled in the art that the invention is applicable to the manufacture of other heat-dissipating structures as mentioned above in connection with previous embodiments.

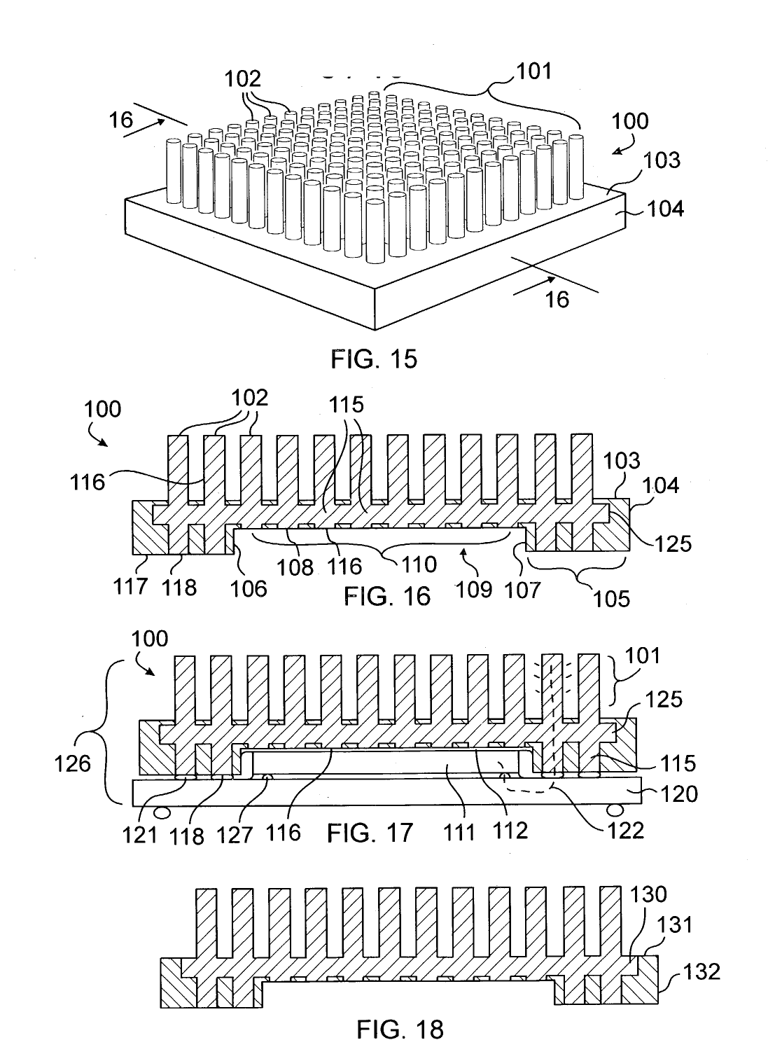

Referring now to FIGS. 15-17, there is shown a flip chip lid 100 having an integrated radiator structure 101 made up of a plurality of radiating prominences 102 extending upward from the upper surface 103 of a generally quadrangular body 104 having a thickened periphery or flange 105 terminating at inner edge walls 106,107 and an underside surface 108 forming an underside cavity 109. A medial region 110 of the underside surface corresponds to an area contacted by a microelectronic die 111 or its bonding layer 112 of material such as solder, thermal epoxy, or thermal grease.

Each of the prominences 102 extend downward through the body 104 forming a heat conduit 115 which terminates at a lower facing end pad 116. Medially located prominences/conduits terminate in pads within the region of die contact 110, whereas more peripherally located prominences/conduits 116 terminate at end pads 118 on the lower surface 117 of the peripheral flange 105 of the body 104.

The medial pads are therefore situated to be close to the heat generating die 111 separated by the chip-to-lid bonding layer 112. The peripheral pads 118 are situated to be close to the chip carrier or substrate 120, separated by the substrate-to-lid bonding layer 121. In this way, a thermal path 122 is created from the die, through the substrate, then back up through the peripheral heat conduits to the radiator, for conducting a greater amount of heat away from the die.

Preferably, each of the conduits 115 passes through a heat reservoir 125 formed into the body 104 of the lid between the upper and lower surfaces 103,117. The heat reservoir structure interconnects two or more of the conduits, and most preferably all of the conduits so that heat variations between conduits are efficiently addressed. In other words, the full heat dissipating capacity of the radiator is accessible to each of the conduits. This also tends to maintain a uniform temperature across the surface of the die thereby minimizing local thermal stresses.

The radiator structure 101, heat conduits 115, and heat reservoir 125 are formed from a high thermal conductivity material such as copper. The remainder of the body 104 of the lid is formed from a CTE compatible material such as a homogeneous metal matrix composite of tungsten and copper. Those skilled in the art will readily appreciate the other materials which may be adequately used. For example, in addition to copper, the high thermal conductivity material could be silver, silicon-carbide, and carbon-copper composites. If a metal matrix composite is used for the CTE compatible material, then that material could be, in addition to tungsten-copper, for example, molybdenum-copper, copper-graphite and molybdenum.

As shown in FIG. 17, the integrated lid 100 is bonded to the flip chip 111 and the substrate 120 using a bonding layer 121,112 of a material such as solder to form the flip chip enclosing package 126. Care must be taken to select the type of solder for the bonding layer so that the temperature required to reflow it during attachment to the chip and substrate does not damage existing bonds such as the typical solder bond 127 between the chip and substrate. In addition, the type of solder selected for the bonding layer should be capable of forming bonds which withstand the temperature of any solder reflow processes such as gold-tin micro ball grid array (Micro BGA) used to surface mount the substrate to a circuit board.

In an alternate embodiment, as shown in FIG. 18, the heat reservoir structure 130 is formed on the upper surface 131 of the body 132 of the lid. This embodiment is suited to a less demanding thermal expansion environments and is typically less expensive to fabricate.

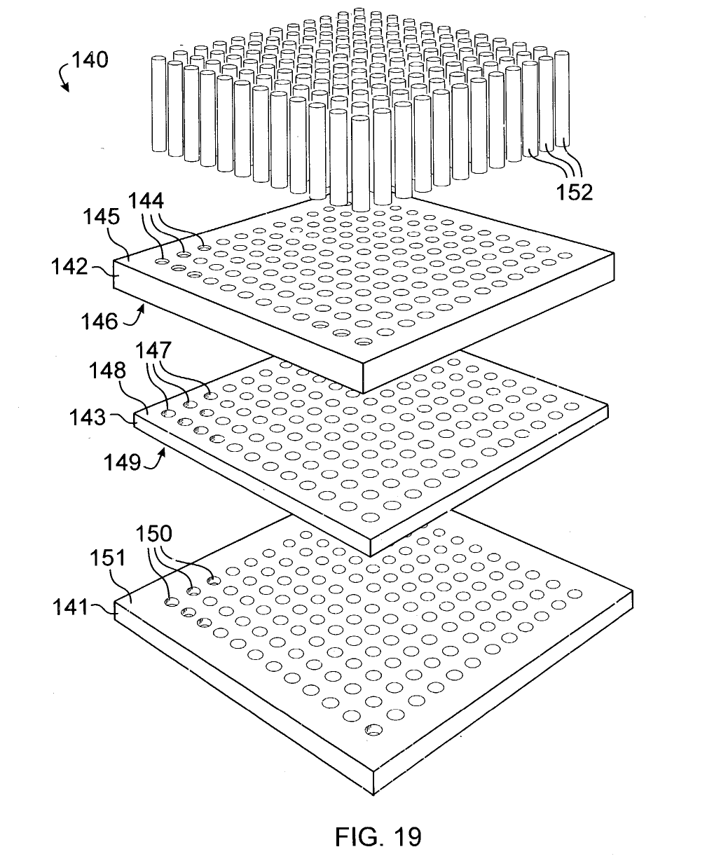

Referring now to FIGS. 19-22, the preferred process for manufacturing the above described flip-chip lid will now be described. In general, the body of the lid is made from a metal matrix composite material combining a higher melting point, low thermal expansion matrix material such as tungsten with a lower melting point, higher thermal expansion and high thermal conductivity infiltrant material such as copper. To reduce processing steps, it is preferable that the heat conduits, heat reservoir, and radiator structures are made from the same lower melting point infiltrant metal used to form the body, such as copper.

As shown in FIG. 19, the lid begins as a predrilled preassembly 140 wherein the body is formed from a bottom preform 141, and top preform 142 of porous matrix material, sandwiching a plate 143 of infiltrant material. The top preform has an array of perforations 144 penetrating through from a top surface 145 to a bottom surface 146. The plate 143 has a corresponding array of holes 147 coaxially located in relation to the perforations and penetrating through from a top surface 148 to a bottom surface 149. Similarly, the bottom preform 141 has a corresponding array of wells 150 coaxially located in relation to the perforations and extending from a top surface 151 down a distance into the preform. Rods 152 of infiltrant material are selected to be inserted into the perforations/holes/wells. The perforations, holes, wells, and rods are sized and located to correspond to the heat conduit and radiator prominence structure in the finished lid.

The following process step will be described wherein tungsten has been selected as the matrix material and copper selected as the infiltrant material. Those skilled in the art will readily appreciate the applicability of the steps using other materials.

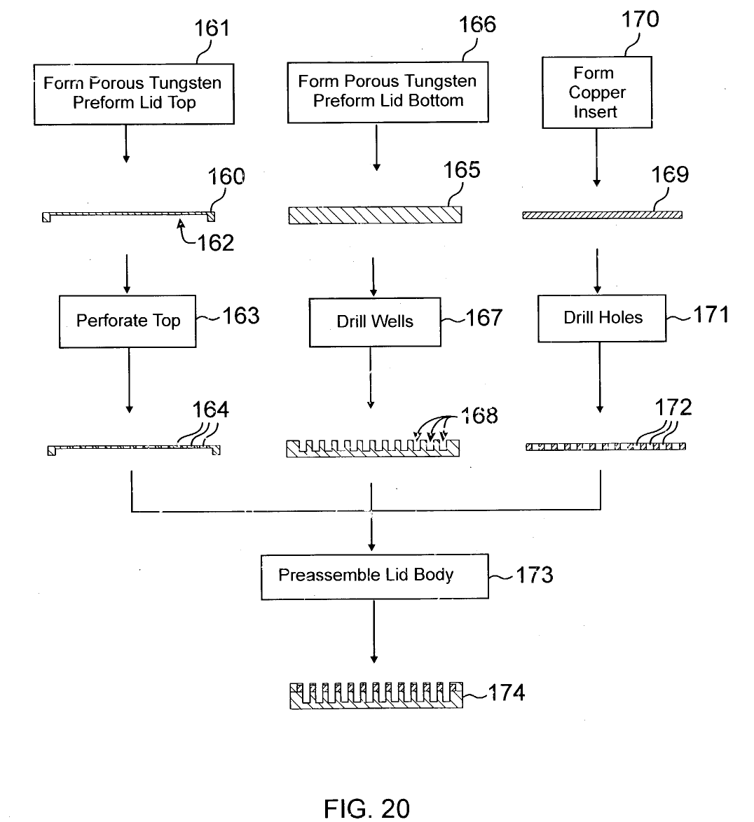

As shown in FIG. 20, the preform top 160 is formed 161 through powder metallurgy techniques well known in the art. An amount of tungsten powder is selected and pressed to form a compact which is then sintered into a porous preform having a porosity capable of being later infiltrated with molten copper. The top is either formed or machined to have an underside cavity 162 sized to enclose the copper plate. The porous preform top is then perforated 163 to have an array of perforations 164 in size and location to correspond to later heat conduit structures, and potentially, the later radiator prominence structures. It should be noted that the size, number, and shape of the heat conduits and radiator prominence structures are preferably selected after careful thermal management analysis in a given device and application. Such analyses are well known to those skilled in the art.

The preform bottom 165 is separately formed 166 through a process similar to the preform top described above, and drilled 167 to form an number of right cylindrical wells 168 equal to the number of perforations, and sized and located to correspond to the later heat conduit structures.

The copper plate 169 is formed 170 to be insertable into the cavity of the top preform. The plate is also drilled 171 to form holes 172 which coaxially line up with the perforations and wells.

The porous tungsten top preform, copper insert, and porous tungsten bottom preform are then preassembled 173 to form the lid body preassembly 174.

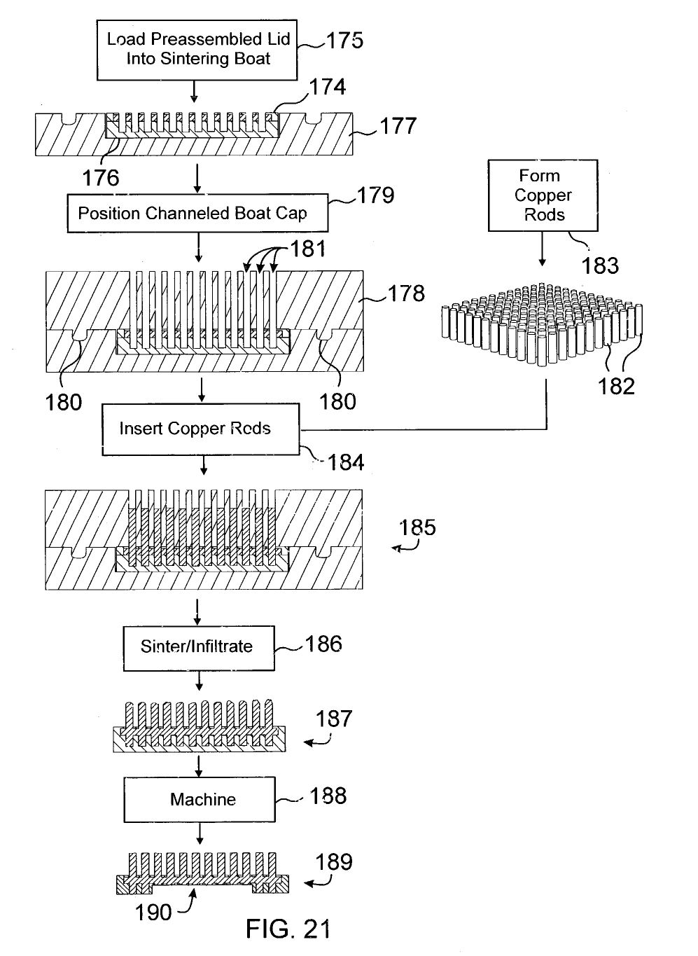

As shown in FIG. 21, the lid body preassembly 174 is loaded 175 into a holding slot 176 of a graphite sintering boat 177. A graphite boat cap 178 is then precisely positioned 179 using aligning guide pins 180 atop the lid body preassembly so that cylindrical channels 181 in the cap are aligned to the perforations in the body preassembly.

Copper rods 182 are formed 183 having lengths and diameters which will allow insertion 184 into the aligned channels, perforations, holes, and wells to form the preinfiltrated lid in the sintering boat 185.

The boat with the preinfiltrated lid is then sintered 186 by being placed in a sintering oven causing the copper to melt and flow into the pores of the preforms and completely fill the perforations/holes/wells to form the heat conduits. The cavity between the preforms is filled to form the heat reservoir. The copper remaining in the cap channels forms the prominences of the heat dissipating radiator structure of the premachined sintered integrated lid 187.

Once cooled, the infiltrated lid is then machined 188 to form the pre-die-attach finished lid 189 by properly sizing the prominences and creating the die containing cavity 190.

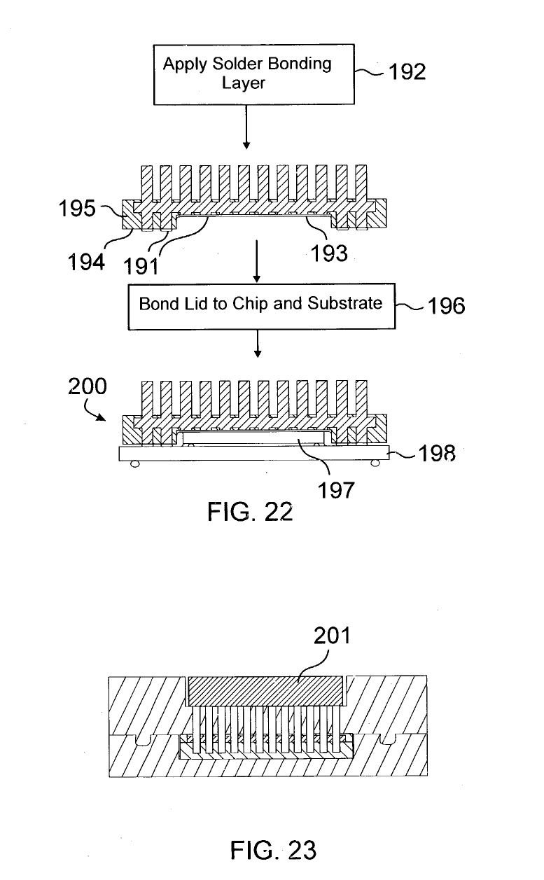

As shown in FIG. 22, prior to forming the flip-chip package, a solder bonding layer 191 is formed 192 on the undersurface 193 of the lid and the lower surfaces 194 of the lid periphery 195. The lid is then bonded 196 to the flip-chip die 197 and substrate 198 to form the finished package 200.

Referring now to FIG. 23, in an alternate process embodiment, rods may be replaced with a slab 201 of copper placed above the channels prior to sintering, which will flow down the channels to form the necessary structures. This process is indicated when a particularly large number of prominences/heat conduits are required.

### EXAMPLE 2

Below are provided a range of parameters and those most preferred in this particular example. Preferred and most preferred values will vary greatly depending on the application.

An amount of tungsten powder is selected having a particle diameter of between about 0.1 and 100 microns and more preferably, an average particle diameter between about 0.5 and 25 microns. The powder is at least approximately 99.0% tungsten with the remainder being binder or impurities. Such powder is available from Osram-Sylvania of Towanda, Pa.

The tungsten powder is loaded into a hopper which feeds powder into a ram-type press-molding tool which operates at room temperature under a pressure of between about 35 and 75 tons per square inch (“tsi”), and most preferably about 55 tsi. Ram speeds were selected to range between about 2 and 30 inches per second (“ips”), and most preferably about 10 ips. Dwell time at pressure was selected to range between about 2 and 20 seconds, and most preferably about 5 seconds. Ejection speeds were selected to range between about 2 and 25 ips, and most preferably about 10 ips.

The press ejects a porous compact structure measuring approximately 2.5 inches×2.5 inches×0.2 inches in the shape of the top and bottom structure of lid body. The top was formed to have an underside cavity dimensioned to accommodate the reservoir preform plate. The resulting porous green compacts had a density of between about 63% and 89% of theoretical and most preferably approximately 76% of theoretical.

The compact was placed in a continuous sintering furnace having preheat, high temperature and cooling zones and a reducing atmosphere. The high temperature zone, which has the greatest effect on the sintering, was set between about 1150 degrees C. and 1350 degrees C., most preferably about 1250 degrees C. Exposure time was between about 15 and 120 minutes, most preferably about 60 minutes.

The resulting sintered porous preforms of the top and bottom body structures exhibited a density of between about 65% and 90% of theoretical and most preferably approximately 85% of theoretical.

After cooling, the sintered porous preforms were drilled in a CNC type drilling machine. The top preform was drilled through to form cylindrical bores having a diameter between about 0.031 and 0.0625 inch, and most preferably about 0.040 inch. Distance between hole centers was at least 1.5 time the hole diameter, and most preferably about 2 times the hole diameter. The pattern of the bores was an orthogonal grid. The bottom preform was drilled with a flat head, end mill-type bit to create substantially right cylindrical wells of a depth of between about 0.05 inch and 0.15 inch and most preferably about 0.1 inch.

An “oxygen free high conductivity” type quadrangular copper plate having 99.9% minimum copper content, the remainder being other alloying elements and impurities, was selected measuring approximately 2.3 inches×2.3 inches×0.1 inches to fit within the top preform cavity. The plate was drilled through to form cylindrical holes commensurate with the bores and wells of the body preforms.

A series of right cylindrical copper rods of the same copper type as the plate, and measuring about 0.5 inch in length and about 0.04 inch in diameter were formed from techniques well known on the art. Such rods are commercially available from the McMaster Catalog Company, well known in the art.

The top and bottom preforms, and the copper plate were preassembled sandwiching the plate between the preforms. The preassembly was staged in a graphite boat and covered by a graphite cover having cylindrical channels commensurate with the perforations, holes and wells of the preassembly. A copper rod was then inserted into each of the aligned channels/perforations/holes/wells.

The loaded boat was then placed in a continuous sintering oven. In this infiltration oven, the high temperature zone was set between about 1100 degrees C. and 1350 degrees C., most preferably about 1150 degrees C. Exposure time was between about 1 hour and 8 hours, most preferably about 5 hours.

After cooling, the resultant lid was extracted from the boat and machined to remove excess copper, and form the underside die cavity. The lid was then cleaned using techniques well known in the industry to form the finished flip chip lid.

The lids were then fed into an automated solder shooter dispensing solder having a melting temperature of temperature of between 200° C. and 240° C., and most preferably between about 220° C. and 230° C. to accommodate prior applied materials and later process temperatures. The lids were then heated to reflow the solder to form a solder bonding layer bond line of less then about 0.001 inch.

While the preferred embodiments of the invention have been described, modifications can be made and other embodiments may be devised without departing from the spirit of the invention and the scope of the appended claims.

What is claimed is:

1. A process for manufacturing a heat-dissipating element of a micro-electronic package, said process comprises:
forming a porous preform of a first material having a first melting point and having bores extending between first and second surfaces;
infiltrating a second material having a melting point lower than said first melting point into said preform, thereby filling said bores; and
machining said infiltrated preform to form a finished element.

2. The process of claim 1, wherein said forming a preform comprises pressing an amount of powdered particles of said first material.

3. The process of claim 2, wherein said pressing comprises embossing said bores during said pressing using a die press.

4. The process of claim 2, wherein said forming further comprises drilling said bores into said compact.

5. The process of claim 1, which further comprises selecting a location of a plurality of bores to form a readable symbol.

6. The process of claim 1, wherein said step of forming comprises creating bores having greater thickness in a medial portion of said preform and a narrower thickness in an adjacent peripheral portion of said preform.

7. The process of claim 1, wherein said first material is selected from the group consisting of tungsten, molybdenum, rhenium, iron-nickel alloys, iron-nickel-cobalt alloys and composites and alloys thereof.

8. The process of claim 1, wherein said second material is selected from the group consisting of copper, tin, lead, germanium, gold, silver, indium, gallium, mercury and composites and alloys thereof.

9. A heat-dissipating element made from the process of claim 1.

10. A heat-dissipating element for packaging a microelectronic device comprises a metal matrix composite body having a first surface for contacting said device and an opposite second surface and a plurality of heat conduits wherein each of said heat conduits has a first pad coplanar with said first surface and a second pad coplanar with said second surface, wherein a first of said heat conduits is made from a material having a thermal conductivity greater than the material of said body.

11. The element of claim 10, wherein said first material is selected from a group consisting of tungsten, molybdenum, rhenium, iron-nickel alloys, iron-nickel-cobalt alloys and composites and alloys thereof.

12. The element of claim 10, wherein said second material is selected from the group consisting of copper, tin, lead, germanium, gold, silver, indium, gallium, mercury and composites and alloys thereof.

13. The element of claim 10, wherein the location of said heat conduits is selected to form a readable symbol.

14. The element of claim 10, wherein said first one of said heat conduits has a generally conical shape.

15. The element of claim 10, wherein said first pad has a surface area smaller than a surface area of said second pad.

16. The element of claim 10, wherein said first heat conduit has a first volume and is located in a central medial portion of said body and a second of said heat conduits has a second volume and is located at a location peripheral to said first heat conduit, wherein said second heat conduit has a volume less than said first volume.

17. The element of claim 10 wherein said conduits extend above said second surface to form heat dissipating prominences.

18. The element of claim 10 which further comprises a heat reservoir interconnecting said conduits.

19. The element of claim 18 wherein said reservoir is formed between said first and second surfaces.

20. The element of claim 10 which further comprises at least one additional heat conduit extending through said flange.

21. The process of claim 1, which further comprises placing an infiltrant rod into said bore prior to said sintering.

22. The process of claim 21, wherein said placing an infiltrant rod comprises placing a rod which extends above said top surface.

23. The process of claim 1, which further comprises placing said preform into a sintering boat having a cover having channels formed therein.
